(19) United States
(12) Patent Application Publication
(10) Pub. No.: US 2008/0187245 A1
(43) Pub. Date: Aug. 7, 2008

(54) Image Processing Apparatus, an Imaging System, a Computer Program and a Method for Enabling Scaling of an Object in an Image

(75) Inventors: Raymond Joseph Elisabeth Habets, Eindhoven (NL); Rutger Nijlunsing, Eindhoven (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS, N.V., EINDHOVEN (NL)

(21) Appl. No.: 11/569,599

(22) PCT Filed: May 25, 2005
(86) PCT No.: PCT/IB05/51704

§ 371 Date: Nov. 27, 2006

(30) Foreign Application Priority Data
May 28, 2004 (EP) 04102401.9

(51) Int. Cl. G06T 3/40

(52) U.S. Cl. 382/298

(57) ABSTRACT

The invention relates to an image processing apparatus arranged to scale an object within an image, said image processing apparatus comprising a calibrator arranged to scale the object based on a calibration factor derived from a relationship between a true dimension of a marker and a dimension of the marker in pixel units in the image, wherein the calibrator is further arranged to generate a plurality of calibration factors obtained using a plurality of differently oriented markers identified within said image. The image (I) comprises a plurality of objects (3, 8, 9) which are oriented differently in space resulting in a different alignment of these objects with respect to the anatomical structures (2). The object (3) is linked to a measurement tool, which is arranged to measure a length of the object (3) in pixel units and to calculate a true length of the object (3) using a calibration factor determined from a marker (A), which has a similar alignment in space as the object (3). The image (I) further comprises objects (8, 9), linked to a measurement tool, which is arranged to calculate a true length of the objects (8, 9) based on respective lengths of these object in pixel units and a calibration factor determined using the marker (B). Preferably, the objects corresponding to a different marker are grouped to form a calibration group, whereby an update in the calibration factor results in an automatic update of true dimensions for all objects within the same calibration group. Preferably, each calibration group is identified differently for user's convenience. The invention further relates to an imaging system, a computer program and a method for enabling scaling of objects in the image.

The invention relates to an image processing apparatus arranged to scale an object within an image, said image processing apparatus comprising:

an input arranged to input a pre-determined true dimension of a marker into a calibrator;

the calibrator arranged to scale the object based on a scaling factor determined from a relationship between the true dimension of the marker and a dimension of the marker in pixel units in the image.

The invention further relates to an imaging system.

The invention still further relates to a method for enabling scaling of an object within an image based on a scaling factor determined from a relation between a pre-determined true dimension of a marker and a dimension of the marker in pixel units in the image.

The invention still further relates to a computer program.

An embodiment of an image processing apparatus as is set forth in the opening paragraph is known from U.S. Pat. No. 6,405,071. The known image processing apparatus is arranged to determine a length of a root canal from an X-ray image thereof, said image comprising a projection of a marker aligned with the root canal and being conceived to be used for scaling purposes. The marker has a pre-known length. Thus, a relationship, notably a ratio between a dimension of the marker in pixel units and its true length yields an image scaling factor. The measured length of the root canal will be scaled according to its length in pixel units and the scaling factor.

It is a common practice to use a marker for determination of the image scaling factor. The marker is a foreign object suitably aligned in relation with the object to be scaled and imaged together with the object. For purpose of obtaining the scaling factor, a user manually delineates the marker, for example by indicating two points for a length measurement, using a suitably arranged graphic user interface. Subsequently, the user executes a suitable computation routine for a calculation of a dimension of the marker in pixel units. When the dimension of the marker in pixel units is determined, the user manually inputs the true dimension of the marker using a suitable input, so that a suitable calibrator of the image processing apparatus calculates the scaling factor.

It is a disadvantage of the known image processing apparatus that a procedure of establishing the scaling factor is time consuming and is subject to human errors. These errors might propagate into an error in a value of the object size, which is unacceptable.

It is an object of the invention to provide an image processing apparatus where the determination of the scaling factor is enabled with high reliability.

To this end the image processing apparatus according to the invention further comprises an image processing tool arranged to delineate a feature in the image with a graphic template linked to a measurement tool arranged to determine a dimension of the feature in pixel units, the calibrator being further arranged to use the feature as the marker.

The technical measure of the invention is based on the insight that it is advantageous to provide an automatically delineated graphic object to the user, said graphic object being linked to a suitable associated measurement for purposes of establishing the scaling factor. According to the technical measure of the invention the marker is assigned to an image feature, which is automatically drawn in the image, whereby its dimension in pixel units is automatically determined by a measurement tool. Thus, the delineated image feature can be used as the marker for image scaling purposes. Any feature in the image with a known dimension may be used as the marker. The term ‘feature’ is attributed to any identifiable item in the image, which has a pre-determined true dimension, notably a length and is thus suitable for image scaling purposes. For example, the feature may be based on two landmarks, a line between two landmarks, a circle with a diameter or a radius, or any other suitable one- or multi-dimensional object comprising a plurality of pixels. Additionally, the feature may be obtained from a suitable image segmentation step, which is arranged to provide a suitable shape, for example, positioned on top of a specific part of an anatomy or a further object shown in the image.

According to the technical measure of the invention the calibrator is arranged to use the delineated feature as the marker for image scaling purposes. Thus, the user does not have to manually delineate the marker, which improves the accuracy and reliability of the image scaling step. Suitable graphic routines operable to calculate the dimension in pixel units are known per se in the art. Preferably, if the image processing apparatus according to the invention is used for a certain type of images, for example for planning an implant, the graphic template may comprise the pre-determined true length of the envisaged marker, the user having only to confirm the value of the true length using the input, or, otherwise, to use the input to edit said value accordingly. Upon a completion of the image scaling step, the true dimension of the object conceived to be scaled will be determined with high precision and without a substantial user interaction.

It is found to be preferable that the graphic template not only provides a suitable marker, but also automatically delineates the object conceived to be scaled. A plurality of suitable means for delineating an object within the image are known per se in the art, the examples comprising any suitable image matching or segmentation techniques.

In an embodiment of the image processing apparatus according to the invention the measurement tool is defined within a geometric relational application framework macro.

According to this technical measure the geometric relational application framework macro is used for an image calibration step. This is advantageous, as the geometric relational application framework macro can be configured to interrelate a plurality of objects in such a way, that when a single object is repositioned, the other objects related to it are repositioned accordingly. This results not only in a provision of a fully automated image processing, but also in a provision of a highly reliable delineation, measurement and calibration means.

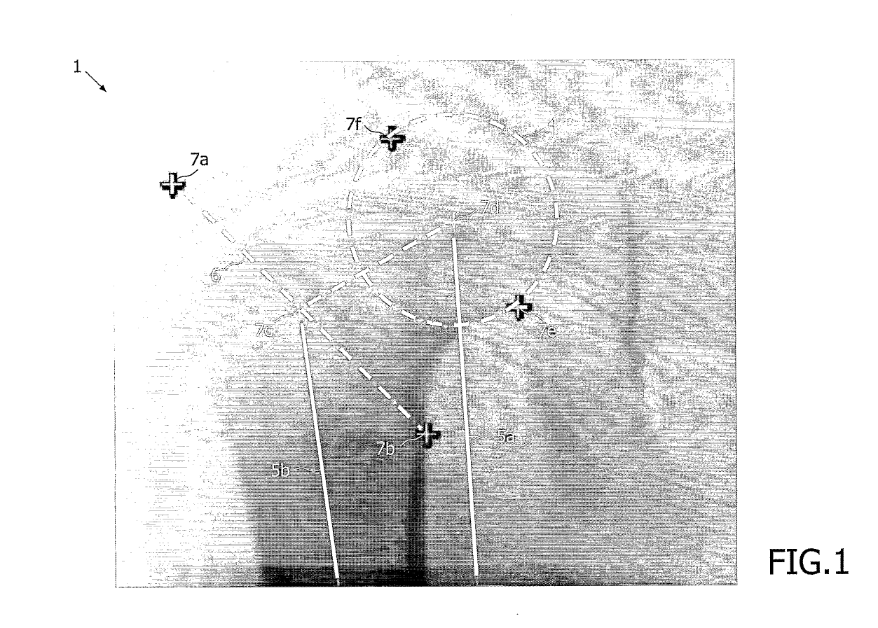

An embodiment of the image handling using the geometric relational application framework macro is known from WO/0063844, which is assigned to the present Applicant. The geometric relational application framework macro is arranged to provide detailed descriptions of various geometric templates defined within the image, in particular to structurally interrelate said templates within geometry of the image, thus providing a structural handling of various geometrical templates so that a certain pre-defined geometrical consistency between the templates is maintained. The geometric relational application framework macro further enables analysis and/or measurement of geometrical properties of anatomical structures, when the structure is provided with a suitable landmark. A broad variety of possible geometric relations between pre-definable geometric templates, like a circle, a line, a sphere, etc., is possible and is defined within the geometric relational application framework macro. The geometric template is operable by the geometric relational application framework macro using a landmark, or a set of landmarks associated with the geometric template. FIG. 1 shows an embodiment of the known geometric template controllable by the geometric application framework macro which is arranged to define geometrical relations between a plurality of geometric templates.

In a further embodiment of the image processing apparatus according to the invention a plurality of objects is interconnected within the geometric relational application framework macro.

It is found to be particularly advantageous to interrelate a plurality of objects for scaling purposes. This measure has an advantage that in case when a scaling factor is updated, for example due to a user interaction, the true dimension of each respective interrelated object is automatically updated. This feature further improves user-friendliness and reliability of the image processing apparatus according to the invention.

An imaging system according to the invention comprises a display and the image processing apparatus, as is set forth in the foregoing. Advantageously, the imaging system according to the invention further comprises a data acquisition unit connectable to the image processing apparatus. In this way an easy to operate data acquisition and processing system is provided, whereby the user is enabled to carry out necessary image processing steps with high reliability.

The method according to the invention comprises the following steps:

delineating the marker in the image using a graphic template linked to a measurement tool arranged to determine a dimension of the marker in pixel units;

obtaining a true dimension of the feature;

using the feature as the marker;

calculating the scaling factor;

scaling the object using the scaling factor and a dimension of the object in pixel units.

According to the method of the invention the user is enabled to carry out necessary image scaling steps easy and reliably, whereby a measurable graphic object based on an image feature is provided for a direct calculation of the scaling factor. Further advantageous embodiments of the method according to the invention are set forth in claims 8, 9.

The computer program according to the invention is arranged to cause a processor to carry out the steps of the method as is set forth in the foregoing. The computer program comprises suitable subroutines arranged to load image data and to run a measurement protocol. The measurement protocol is arranged to initiate a toolkit macro that arranged to delineate a feature in the image. Preferably, the graphic template is positioned in the image using suitable image matching techniques. For example, when the user selects a feature to be represented by a standard geometric shape, for example a circle or a line, the matching subroutine carries out an automatic matching between a part of the image and the template, by suitably sizing and displacing the template. When the geometric template is placed, the measurement routine is executed, resulting in a dimension of the feature in pixel units. When the true dimension of the feature is input, the calibration routine automatically calculates the scaling factor, which is applicable for all objects conceived to be scaled within the image. The user may alter the value of the true size of the feature, the calibration and scaling being updated automatically.

These and other aspects of the invention will be described in further detail with reference to figures.

FIG. 1 presents in a schematic way an embodiment of a two-dimensional geometric relational application framework macro (state of the art).

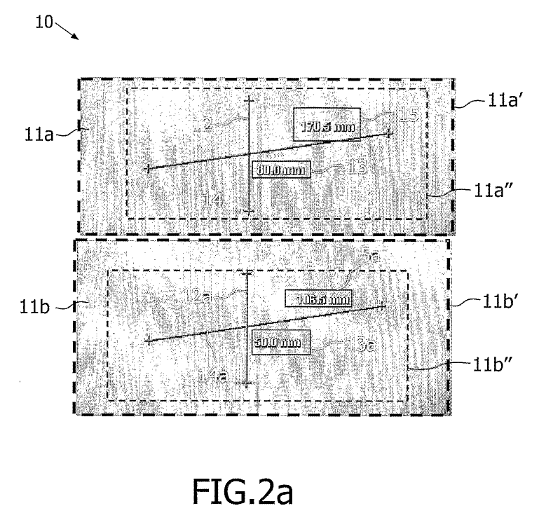

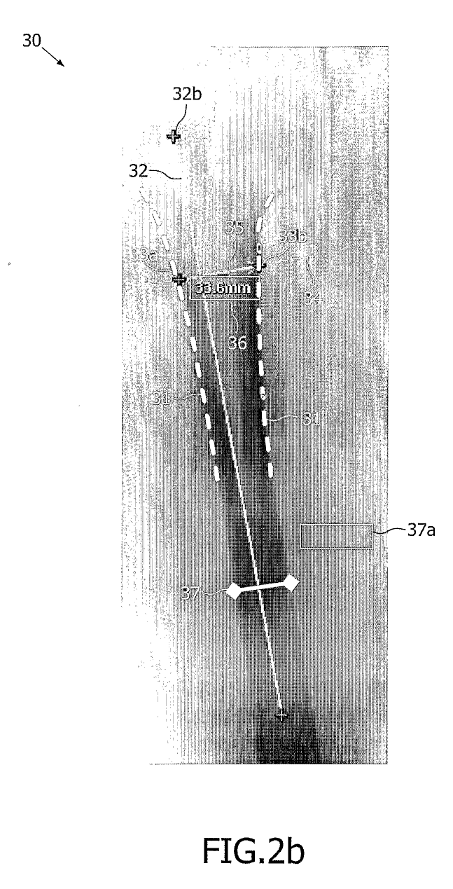

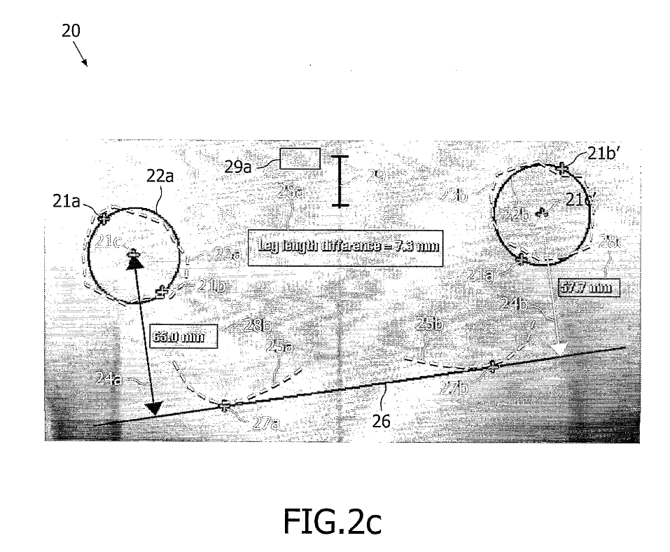

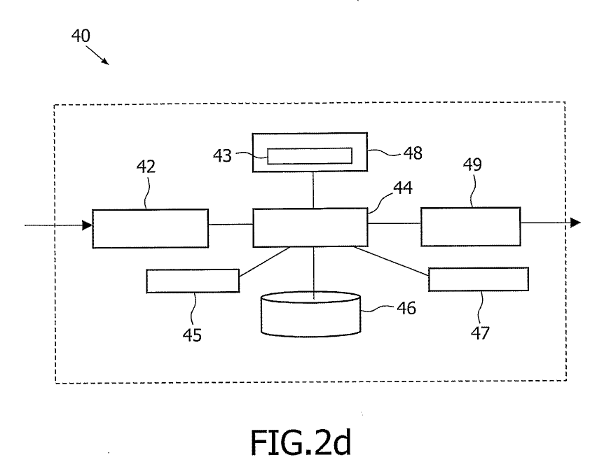

FIG. 2a presents in a schematic way an embodiment of a graphic template according to the invention.

FIG. 2b presents in a schematic way a further embodiment of the graphic template according to the invention.

FIG. 2c presents in a schematic way a still further embodiment of the graphic template according to the invention.

FIG. 2d presents in a schematic way an embodiment of an image processing apparatus according to the invention.

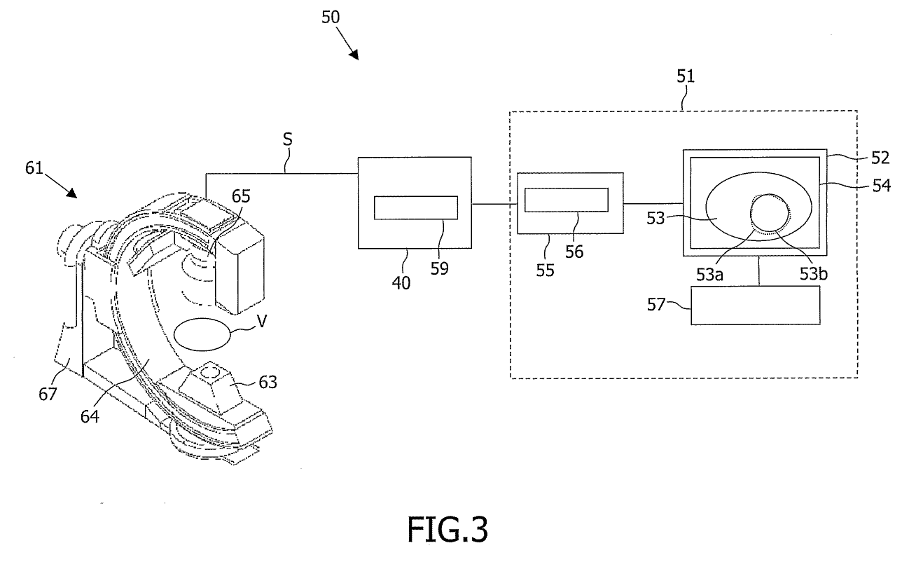

FIG. 3 presents in a schematic way an embodiment of the image processing system according to the invention.

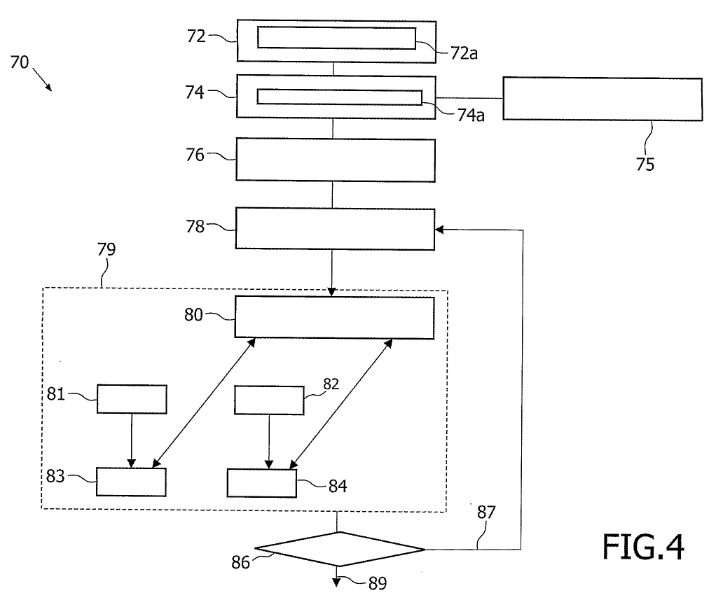

FIG. 4 presents in a schematic way an embodiment of a workflow of the method according to the invention.

FIG. 1 presents in a schematic way an embodiment of a known two-dimensional geometric relational application framework macro 1, which is arranged to define geometrical relations for the geometric templates 4, 5a, 5b, 6. The known geometric relational application framework macro is further arranged to maintain the defined geometrical relations once any geometrical template is repositioned. The respective geometrical templates are defined using respective associated landmarks 7a, 7b, 7e, 7f. The geometric application framework macro can also be arranged to operate a three-dimensional geometric template (not shown).

FIG. 2a presents in a schematic way an embodiment of a graphic template according to the invention. In order to illustrate the effect of the graphic template according to the invention on the calibration and scaling process, processing of image 10 is shown in two temporary consecutive steps 11a and 11b. At step 11a the image 10 comprises image data 11a′ onto which a graphic template 11a″ is overlaid. The graphic template 11a′ is arranged to delineate a feature 12. The graphic template 11a′ is linked to an associated measurement tool for determination of the dimension of the feature 12 in pixel units. The user may input the true length of the feature in the interactive window 13. When the calibrator selects the feature 12 as the marker for image scaling purposes, the scaling factor is determined, for example based on a ratio between the true dimension of the thus defined marker and its pixel length in the image 10. Preferably, the scaling factor is fed back (not shown). The graphic template 11a″ further comprises an object 14, which is conceived to be scaled to its true dimension using the scaling factor. For user's convenience the corresponding reading is shown in window 15. It must be noted that according to the invention, the calculation of the scaling factor and the calculation of the true length of the object are provided automatically and without user's interaction, in case when suitable calibration routine uses a default value of the true dimension of the marker. In case a marker of another dimension is used for calibration, the user may edit the value in window 13, as is shown at step 11b. In this case the user uses a suitable user interface to change the default value of 80.0 mm to, for example 50.0 mm, the true dimension of the object 15a being updated automatically. It is shown that according to the technical measure of the invention, the user does not have to spend his time on delineating the marker and the object, them being overlaid automatically on the image using suitable graphic templates. Therefore, the image scaling step is user friendly and is reliable, thus reducing mistakes due to human errors. Although a very specific example is shown in this figure, those skilled in the art appreciate that a plurality of possibly suitable measurement tools may be overlaid on the image and may be made available to the user for scaling purposes. Preferably, the position of the marker and the object conceived to be scaled are delineated automatically using suitable techniques, for example image segmentation. Alternatively, the user may delineate and/or edit an automatic delineation of the object himself.

FIG. 2b presents in a schematic way a further embodiment of the graphic template according to the invention, whereby a graphic template comprises a measurement tool arranged within a geometric relational application framework macro. In this example an automatic diameter measurement of a human femur is shown. The solid lines 32, 34 represent graphic templates within the geometric relational application framework macro: a line 32 modeling the femoral axis, a second perpendicular line 34 modeling a direction of a diameter measurement 35. This perpendicular line 34 is arranged to contain two graphic templates, namely two point objects 33a, 33b with an associated distance measurement, all being defined within the geometric relational application framework macro. In this example, open contours 31 are associated with the points 33a, 33b. These contours position themselves automatically along the edges of the femoral bone using a suitable image segmentation technique. Through specifically defined relations between the line 34, the line 32 and the contours 31, the positions of the two point objects 33a, 33b are automatically adapted to the intersection of the perpendicular line 34 and each graphic object 31. The image 30 further comprises a delineated feature 37, which is used as the marker for image scaling purposes. The marker 37 is preferably overlaid on an object with a known dimension, for example a ruler or, alternatively an image of an implant or a screw may be used as well. A corresponding scaling factor or a true length of the marker is being fed-back to the user in the window 37a. In case when the scaling factor is changed, for example due to editing of the true length of the marker, the reading of the true distance 36 is updated automatically. Also, the reading of the true distance 36 is automatically updated in case when a position of any of the lines 31, 32, 34 is changed, leading to a different reading of a length for a trajectory 35 between new points 33a and 33b. Thus, in case when the user picks up the perpendicular line 34 and moves it along the femoral axis, the diameter measurement 35 will adapt dependent on the current femur diameter at a new location of the perpendicular line 34. According to this technical measure, a versatile and easy to operate image processor is provided, whereby due to coupling between the graphic objects in a geometric relational application framework macro, any repositioning of the objects automatically lead to an update of the true dimension of the object of interest 35, using the scaling factor.

FIG. 2c presents in a schematic way a still further embodiment of the graphic template according to the invention, whereby a plurality of objects is associated. This particular embodiment illustrates an application related to a measurement of a leg length difference based on an X-ray image. Any suitable implementation for associating geometric objects in the image 20 is possible, including, but not limited to a geometric relational application framework macro. Any other suitable image from any other suitable imaging modality may as well be used for practicing the invention, the invention being not limited to a medical domain. The objects inter-related by the geometric relational application framework macro comprise two circles 22a, 22b arranged for modeling of size and position of corresponding femoral heads, and a line 26 arranged for indicating the base of the pelvis. Distances from both circle centers 21c, 21c′ to this baseline 28b, 28c are also part of the geometric relational application framework macro structure and are calculated automatically, using the same scaling factor (not shown) obtained from a suitable marker 29. The true length of the marker 29 is preferably given in a window 29a, which may be edited by the user. Therefore, the difference between the distances 24a, 24b representing the leg length difference is also obtained automatically with high precision.

If one element (circle 22a or line 26) is modified all other elements are automatically updated to reflect this modification. Also, in case the true length of the marker is modified, the measurement of the leg length is updated instantly. According to the technical measure of this embodiment of the invention, objects 23a, 23b, 25a, 25b are associated with respective graphic objects 22a, 22b, 26. These graphic objects are arranged to position themselves automatically along edges or other features of the image data. Through specifically defined relations between graphic objects 22a, 22b, 26 inter-related by the geometric relational application framework macro and the graphic objects 23a, 23b, 25a, 25b, the circles 22a, 22b are positioned to fit optimally to the paths of the closed contours 23a, 23b, while the straight line 26 is positioned such that it touches both open contours 25a, 25b. The graphic template is thus coupled, so that adaptations of the circles 22a, 22b, or the straight line 26 are automatically reflected in the measured distances 28a, 28b. Preferably, the constraints and relations that exist between the geometric objects are arranged to limit the adaptation of these objects, which is in turn automatically translated into limitations for the adaptation of the graphic objects. Such constraints are preferably based on knowledge of anatomical consistency.

FIG. 2d presents in a schematic way an embodiment of an image processing apparatus according to the invention. The image processing apparatus 40 has an input 42 for receiving the image data in any suitable form. For example, the apparatus 40 may be involved in the acquisition of the image data. In this case the image data may be acquired in an analogue form and converted using a suitable A/D converter to a digital form for further processing. The image data may also be received in a digital form, e.g. through direct acquisition in a digital form or via a computer network after having been acquired by another computer/medical instrument. The core of the image processing apparatus is formed by a processor 44 which is arranged to load image data from the input 42 and made these data available for further processing. An example of a suitable processor 44 is a conventional microprocessor or signal processor, a background storage 48 (typically based on a hard disk) and working memory 46 (typically based on RAM). The background storage 48 can be used for storing the image data (or parts of it) when not being processed, and for storing operations of the graphic template and suitable shape models (when not being executed by the processor). The main memory 46 typically holds the (parts of) image data being processed and the instructions of the geometric template and the models used for processing those parts of the image data. The apparatus 40 according to the invention comprises a calibrator 45 arranged to determine respective a scaling factor for the image and to apply the scaling factor to a dimension in pixel units of an object in order to yield its true dimension. The apparatus further comprises image processing tool 47 for delineating a feature in the image using a graphic template linked to a measurement tool. The calibrator 45 is further arranged to use a delineated feature as the marker for image scaling purposes. Preferably, the calibrator 45 and the image processing tool 47 are operable by a computer program 43, preferably stored in memory 48. An output 49 is used for outputting the result of the suitable scaling. For example, if the processor 44 has been loaded with a segmenting program, for example retrieved from the storage 48, then the output may be a segmented structure with an identifiable feature provided with a corresponding calculation of its dimension in pixel units, for example visually indicated on a suitable display (not shown). Preferably, the output comprises a result of the associating of the marker with a delineated feature and a suitable object conceived to be scaled. To obtain the scaling factor, for example a default true length of the marker may be used. The user is then prompted whether he wishes to accept the scaling factor or to edit the true length of the marker. Alternatively, the user may input the true dimension of the marker using the input 42. Various embodiments for the suitable input 42 are possible. For example, a file reader for reading a default value, for example assigned to the graphic template, a graphic user interface, a text editor, an interactive window, or the like.

FIG. 3 presents in a schematic way an embodiment of the imaging system according to the invention. The imaging system 50 according to the invention comprises the image processing apparatus 40 arranged for scaling an object within an image data 59 using a marker associated with a dimension measurement and a calibration routine arranged for calculating a scaling factor from, for example the length of the marker in pixel units and a true length of the marker. The output of the apparatus 40 preferably comprises an image with a scaling factor assigned to it. The output of the apparatus 40 is made available to the further input 55 of a viewer 51. Preferably, the further input 55 comprises a suitable processor arranged to operate a suitable interface using a program 56 adapted to control the user interface 54 so that an image 53 comprising suitable object 53a associated with the marker 53b is visualized. Preferably, for user's convenience, the viewer 51 is provided with a high-resolution display 52, the user interface being operable by means of a suitable user interface 57, for example a mouse, a keyboard or any other suitable user's input device. Preferably, the image analysis system 50 further comprises a data acquisition unit 61. However in this example an X-ray device is shown, other data acquisition modalities, like a CT, magnetic resonance apparatus or an ultra-sound device are contemplated as well. Although in the CT, MR and ultrasound units a pixel size is usually known, an application of the invention for these modalities ensures a quality control, by providing an independent calibrator for purposes of scaling the image. The user may thus choose between either the system calibration, or a calibration based on the marker in the image. The X-ray apparatus is arranged to acquire image data from an object, for example a patient, positioned in an acquisition volume V of the apparatus 61. For this purpose a beam of X-rays (not shown) is emitted from the X-ray source 63. The transmitted radiation (not shown) is registered by a suitable detector 65. In order to enable an oblique imaging, the X-ray source 63 and the X-ray detector 65 are mounted on a gantry 64 which is rotatably connected to a stand 67. A signal S at the output of the X-ray detector 65 is representative of the image data 59.

FIG. 4 presents in a schematic way a workflow of the method according to the invention. At step 74 of the method according to the invention a feature in the image data 72a is overlaid with a graphic template 74a linked to a suitable measurement of its dimension in pixel units. It is possible that before the step 74 a step 72 is executed, wherein a suitable image data 72a is loaded into a suitable image processor. Preferably, the graphic template is loaded from a suitable database 75. Alternatively, the graphic template 74a may be on-line calculated based on the image data 72a, for example, by creating suitably delineated features based on objects present in the image. This operation can successfully be implemented using per se known image segmentation techniques. A feature(s) conceived to be used as marker(s) for scaling purposes may be based on anatomical sites, or on other objects, for example professional calibration markers. At step 76 the feature is selected to be used as the marker, the dimension of the marker in pixel units being calculated using the geometric template 74a linked to a measurement tool. In case a plurality of features is overlaid at step 74, the user may select a features he wishes to use for calibration purposes and provides a true length of the selected feature to the calibrator using a suitable input. This operation may be done by entering a value of the true length using a suitable graphic interface, or by loading the value of the true length of the thus selected marker electronically, for example from a file stored in a suitable database. The value of the dimension of the selected marker in pixel units is forwarded to a suitable calibrator which is arranged to carry out an image scaling in accordance with a relation between the dimension of the marker in pixel units and a true dimension of the marker. Preferably, a ratio between the true dimension of the marker and its dimension in pixel units is used for determination of the scaling factor. It is possible that a default value of the true dimension of the marker is made available to the calibrator automatically. In this case the scaling factor is determined at step 78. Alternatively, the user may be prompted to input a true value of the marker's dimension, the scaling factor being calculated after the user has responded accordingly. When the scaling factor is established, it is automatically applied to the object conceived to be scaled. This operation is schematically illustrated at step 79. Hereby the object 80 is selected, which is assigned a dimension in pixel units 83, which is coupled to at least one landmark 81. Let, for example, a femur head be selected as the object 80. The dimension in pixel units 83 in this case is calculated from a diameter of a circle 81, which is matched to the image of the femur head. It is possible that a plurality of dimensions in pixel units is assigned to one object, this is illustrated by 84, 82. For example a bone may be characterized by a diameter of a femur head and a thickness of the femur bone itself. It is also possible that a plurality of objects (not shown) is coupled to the scaling factor. In this case all these objects will be scaled automatically. Upon an event the corresponding dimensions in pixel units of the object or objects to be scaled is established, the scaling factor obtained at step 78 is applied to them. Preferably, this sequence is carried out in a fully automated fashion. In this case at the step 86 the user is prompted to accept the scaling results. In case the user wishes to edit either the true dimension of the marker, or the dimension of the marker in pixel units, or the dimension of the object in pixel units, he is returned to the calibration routine at step 87. Although in this example an object scaling departing from a calibration marker is illustrated, it is also possible to implement the invention whereby a change in one object is automatically propagated towards a further object associated with it. As follows from the foregoing, according to the method of the invention the user is enabled to carry out an easy and reliable image scaling step thus improving the accuracy of the image processing and image analysis as a whole.

1. An image processing apparatus (40) arranged to scale an object (14) within an image (11a), said image processing apparatus comprising:
an input (42) arranged to input a pre-determined true dimension of a marker into a calibrator;
the calibrator (45) arranged to scale the object (14) based on a scaling factor determined from a relationship between the true dimension (13) of the marker (12) and a dimension of the marker in pixel units in the image, wherein the apparatus further comprises an image processing tool (47) arranged to delineate a feature (12) in the image (11a) with a graphic template (11a″) linked to a measurement tool arranged to determine a dimension of the feature in pixel units, the calibrator (45) being further arranged to use the feature as the marker.

2. An image processing apparatus according to claim 1, wherein the measurement tool (35) is defined within a geometric relational application framework macro (30).

3. An image processing apparatus according to claim 2, wherein a plurality of objects (22a, 22b, 26) is interconnected within the geometric relational application framework macro.

4. An image processing apparatus according to claim 3, wherein a true dimension of each of the plurality of objects is updated by an update of the scaling factor.

5. An imaging system (50) comprising an image processing apparatus (40) according to claim 1 and a display (51).

6. An imaging system according to claim 5, further comprising a data acquisition unit (61) connectable to the image processing apparatus (40).

7. A method for enabling scaling of an object within an image based on a scaling factor determined from a relationship between a pre-determined true dimension of a marker and a dimension of the marker in pixel units in the image, said method comprising the steps of:
delineating a feature in the image using a graphic template linked to a measurement tool arranged to determine a dimension of the feature in pixel units;
obtaining a true dimension of the feature;
using the feature as the marker;
calculating the scaling factor;
scaling the object using the scaling factor and a dimension of the object in pixel units.

8. A method according to claim 7, wherein the graphic template is defined within a geometric relational application framework macro.

9. A method according to claim 8, wherein a plurality of objects is interconnected within the geometric relational application framework macro.

10. A computer program for causing a processor to carry out the steps of the method according to claim 7.
